(19) United States
(12) Patent Application Publication
(10) Pub. No.: US 2015/0244229 A1
(43) Pub. Date: Aug. 27, 2015

(54) SPINDLE MOTOR

(71) Applicant: SAMSUNG ELECTRO-MECHANICS CO., LTD., Gyeonggi-Do (KR)

(72) Inventor: Young Jin BAE, Gyeonggi-Do (KR)

(73) Assignee: SAMSUNG ELECTRO-MECHANICS CO., LTD., Gyeonggi-Do (KR)

(21) Appl. No.: 14/632,806

(22) Filed: Feb. 26, 2015

(30) Foreign Application Priority Data
Feb. 26, 2014 (KR) 10-2014-0022446

(51) Int. Cl. H02K 3/28

(52) U.S. Cl. CPC H02K 3/28

(57) ABSTRACT

Embodiments of the invention provide a spindle motor including a stator including a base plate having a through-hole formed therein, a core provided in the base plate, and a flexible printed circuit applying a current to the core. According to at least one embodiment, the spindle motor further includes a rotor including magnet facing the core, wherein the flexible printed circuit includes a land part formed on one surface of the flexible printed circuit to allow a coil which is wound around the core to be soldered and connected thereto, and a coil leading hole formed to be in communication with the through-hole and formed at a position out of the land part to be separated. According to various embodiments, cold soldering defect and disconnection of the coil is prevented.

### CROSS REFERENCE TO RELATED APPLICATION

This application claims the benefit of and priority under 35 U.S.C. §119 to Korean Patent Application No. KR 10-2014-0022446, entitled, “SPINDLE MOTOR,” filed on Feb. 26, 2014, which is hereby incorporated by reference in its entirety into this application.

### BACKGROUND

1. Field of the Invention

The present invention relates to a spindle motor.

2. Description of the Related Art

A spindle motor is typically installed in a hard disk drive (HDD) or an optical disk drive (ODD) to be used to rotate a disk. To this end, the spindle motor includes a stator and a rotor, wherein the stator includes a base plate, a core, a flexible printed circuit electrically connected to the core, for example, and the rotor includes a magnet facing the core or a hub, as non-limiting examples.

Therefore, the spindle motor is driven to be rotated in an operation principle in which a magnetic field generated when applying a current to the core through the flexible printed circuit provides magnetic force to the magnet provided in the hub to rotate the rotor, thereby rotating the disk mounted on the hub.

Meanwhile, in order to electrically connect the core and the flexible printed circuit to each other, the spindle motor typically uses a method in which a coil wound around the core is led to the outside of the base plate and is then soldered to the flexible printed circuit. The above-mentioned method is disclosed, for example, in U.S. Patent Publication No. 2009/0140588.

Here, the flexible printed circuit is configured to be provided to the outside of the base plate to allow the soldering to protrude to the outside of the base plate or is configured to be provided in a groove formed in a lower portion of the base plate to allow the base plate to include the soldering as disclosed, for example, in U.S. Patent Publication No. 2009/0140588.

### SUMMARY

Accordingly, embodiments of the invention have been made to improve cold soldering defect and disconnection of a coil, which may occur when the coil is soldered to a flexible printed circuit applying a current to a core.

According to at least one embodiment, there is provided a spindle motor capable of easily improving cold soldering defect and disconnection due to a shortening of land size in which a soldering of a coil is performed.

According to at least one embodiment, there is also provided a spindle motor capable of easily improving disconnection of a coil due to vibration of a flexible printed circuit.

According to at least one embodiment, there is provided a spindle motor including a stator including a base plate having a through-hole formed therein, a core provided in the base plate, and a flexible printed circuit (FPC) applying a current to the core. The spindle motor further includes a rotor including magnet facing the core, wherein the flexible printed circuit includes a land part formed on one surface of the flexible printed circuit to allow a coil, which is wound around the core to be soldered and connected thereto, and a coil leading hole formed to be in communication with the through-hole and formed at a position out of the land part to be separated.

According to at least one embodiment, the base plate is provided with an inlet hole through which the flexible printed circuit enters.

According to at least one embodiment, the inlet hole is formed in one side of the base plate.

According to at least one embodiment, the land part and the coil leading hole are positioned in the through-hole.

According to at least another embodiment, there is provided a spindle motor including a stator including a base plate having a through-hole formed therein, a core provided in the base plate, and a flexible printed circuit (FPC) applying a current to the core. The spindle motor further includes a rotor including magnet facing the core, wherein the flexible printed circuit includes a pattern layer formed on one surface of the flexible printed circuit, the pattern layer being made of a metal material and being interposed between the flexible printed circuit and the base plate, a land part to which a coil wound around the core is soldered and connected, the land part being formed on the pattern layer, and a coil leading hole formed to penetrate through the pattern layer.

According to at least one embodiment, the flexible printed circuit is made of polyimide.

According to at least one embodiment, the pattern layer is made of copper foil.

According to at least one embodiment, the base plate is provided with an inlet hole through the flexible printed circuit enters.

According to at least one embodiment, the inlet hole is formed in one side of the base plate.

According to at least one embodiment, the land part and the coil leading hole are positioned in the through-hole.

According to at least one embodiment, the coil leading hole is formed at a position out of the land part to be separated.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view illustrating a spindle motor according to a first embodiment of the invention.

FIG. 2 is an enlarged cross-sectional view illustrating main components of FIG. 1 according to an embodiment of the invention.

FIG. 3 is a cross-sectional view illustrating a spindle motor according to a second embodiment of the invention.

FIG. 4 is an enlarged cross-sectional view illustrating main components of FIG. 3 according to an embodiment of the invention.

FIG. 5 is a cross-sectional view illustrating a spindle motor according to a third embodiment of the invention.

FIG. 6 is an enlarged cross-sectional view illustrating main components of FIG. 5 according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

A spindle motor according to an embodiment of the invention includes a stator and a rotor. In addition, according to at least one embodiment, the stator includes a base plate, a core provided in the base plate, and a flexible printed circuit (FPC) applying a current to the core, and the rotor includes a magnet facing the core.

According to at least one embodiment, the base plate allows the stator to be installed in a hard disk drive (HDD) or an optical disk drive (ODD), as non-limiting examples, in which the spindle motor is installed, and is referred to hereinafter as a ‘base’, a ‘plate’, a ‘frame’, as non-limiting examples.

According to at least one embodiment, the above-mentioned base plate has a sleeve provided in the center thereof to support a shaft in a shaft direction to be rotatable as the rotor and includes the core by forming a holder in the base plate toward an outer of the sleeve.

According to at least one embodiment, the base plate has a through-hole formed therein to be soldered and connected to the flexible printed circuit (FPC) through the through-hole in a state in which coil wound around the core is led or to perform a soldering of the coil in the through-hole. In addition, the base plate has an inlet hole formed therein through which the flexible printed circuit (FPC) enters to allow the flexible printed circuit (FPC) to be disposed in the spindle motor through the inlet hole.

According to at least one embodiment, the magnet is formed in a shape of a ring to be provided in an inner side of the hub rotated on the shaft, thereby facing the core. Here, a fluid, for example, lubricant containing oil is interposed between the shaft and the sleeve, and between the sleeve and the hub, which is typically referred to as a hydrodynamic bearing. However, since the hydrodynamic bearing is well known in the art, a detailed description thereof will be omitted.

Meanwhile, the flexible printed circuit (FPC), which is a configuration for applying an external current to the core, has a land so that the coil led from the core is soldered and connected thereto, as described above. Therefore, a soldering part is formed by soldering the coil to the land.

According to at least one embodiment, the soldering part is generally formed in a dome due to the nature of the soldering. In a through-hole structure forming a coil leading hole, which may lead the coil in the flexible printed circuit (FPC), in the case in which the entire soldering part is positioned in the through-hold of the base plate by soldering the coil in a state in which the flexible printed circuit (FPC) is inserted through the inlet hole formed in the base plate to be disposed in the spindle motor, a size of the through-hole is increased according to the soldering part, which acts as a factor attenuating structural rigidity of the base plate. On the contrary, in the case in which the size of the soldering part is reduced according to the size of the through-hole, cold soldering and disconnection of the coil occurs.

According to at least one embodiment, the positioning of the soldering part in the through-hole formed in the base plate is to accord with thinness and lightening required by a market. According to the soldering part positioned in the through-hole, since the soldering part is included in the base plate so as not to protrude to the outside of the spindle motor, a thickness of a drive is thinned from 9.5 mm to 5 mm.

Therefore, the spindle motor according to an embodiment of the invention forms the coil leading hole in the flexible printed circuit (FPC) to improve the cold soldering and the disconnection of the coil, which are the problems which may occur in the above-mentioned thinning process and forms the coil leading hole to be separated in a position out of the land. Thus, by forming the coil leading hole and the land to be separated from each other, the coil is in contact with the entire soldering part formed by soldering the coil to the land, such that a contact length is increased, thereby stably performing the soldering.

On the other hand, the flexible printed circuit (FPC) is typically formed using polyimide. Consequently, since the flexible printed circuit (FPC) is vulnerable to vibration, the disconnection of the coil may occur due to the vibration of the flexible printed circuit (FPC) in an ultrasonic cleaning process for preventing foreign materials, for example, in the spindle motor.

Therefore, the spindle motor according to an embodiment of the invention forms a pattern layer made of a metal material in order to structurally improve rigidity of the flexible printed circuit formed of polyimide and interposes the pattern layer between the flexible printed circuit (FPC) and the base plate.

According to at least one embodiment, by forming the pattern layer using a copper foil by way of example and interposing the pattern layer between the flexible printed circuit (FPC) and the base plate, the flexible printed circuit (FPC) becomes more robust against the vibration at the time of the ultrasonic cleaning during a process for manufacturing the spindle motor, thereby easily preventing disconnection defect of the coil.

Hereinafter, various embodiments of the invention will be described in detail with reference to the accompanying drawings.

### First Exemplary Embodiment

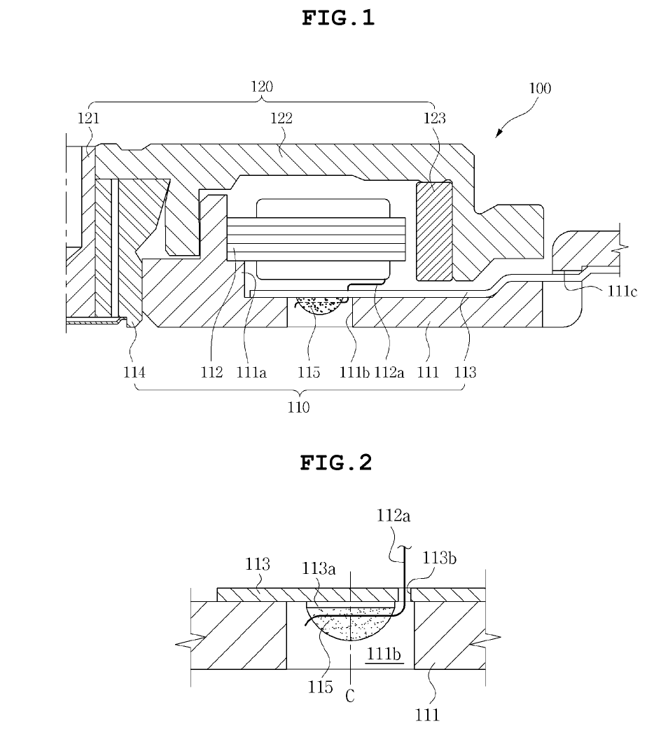

As illustrated in FIG. 1, in a spindle motor 100 according to a first embodiment of the invention, a core 112 around which a coil 112a is wound is coupled to a holder 111a of a base plate 111, a flexible printed circuit 113 is disposed between the core 112 and the base plate 111, and a sleeve 114 is then assembled to the center of the base plate 111, thereby configuring a stator 110. In addition, a shaft 121 is installed in a shaft direction in the sleeve 114, a hub 122 is assembled to an upper portion of the shaft 121, and a magnet 123 is then disposed on an inner side of the hub 122 to face the core 112, thereby configuring a rotor 120.

Therefore, in the spindle motor 100 according to the first embodiment of the invention, the rotor 120 is driven to be rotated on the shaft 121 by electromagnetic force occurring between the magnet 123 and the core 112 at the time of the application of a current through the flexible printed circuit 113, thereby rotating a disk mounted on an upper portion of the hub 122.

According to at least one embodiment, the base plate 111 has a through-hole 111b formed in a lower portion thereof on the drawing and an inlet hole 111c formed in one side thereof to allow the flexible printed circuit 113 to enter from the outside of the spindle motor 100 and accommodates a soldering part 115 formed by soldering the coil 112a in the through-hole 111b. According to at least one embodiment, the through-hole 111b is formed to have a size, which does not deteriorate structural rigidity of the base plate 111, a land part 113a and a coil leading hole 113b formed in the flexible printed circuit 113 are positioned in the through-hole 111b, so that the coil 112a is soldered in the through-hole 111b.

According to at least one embodiment, since the size of the land part 113a is reduced by forming the land part 113a in the through-hole 111b, the land part 113a and the coil leading hole 113b are formed to be separated from each other to prevent cold soldering and disconnection due to the reduction in the size of the land part 113a.

As illustrated in FIG. 2, the flexible printed circuit 113 is a through-hole structure in which the coil leading hole 113b leading the coil 112a is formed and the land part 113a to which the coil 112a led through the coil leading hole 113b is soldered is formed on a lower portion thereof. In this case, the coil leading hole 113b is separated from the land part 113a so as to be formed at a position out of the land part 113a, as described above.

According to at least one embodiment, the coil leading hole 113b is formed to be separated from the land part 113a, such that the center thereof is spaced apart from a central shaft C of the through-hole 111b. However, the coil leading hole 113b is positioned in the through-hole 111b, so that the coil 112a is easily led.

Therefore, according to at least one embodiment, the coil 112a led through the coil leading hole 113b is soldered to the land part 113a in a state in which the coil 112a is bent in a horizontal direction on the drawing in the through-hole 111b, thereby increasing a length which is in contact with the soldering part 115 formed by soldering the coil 112a to prevent cold soldering and disconnection.

### Second Exemplary Embodiment

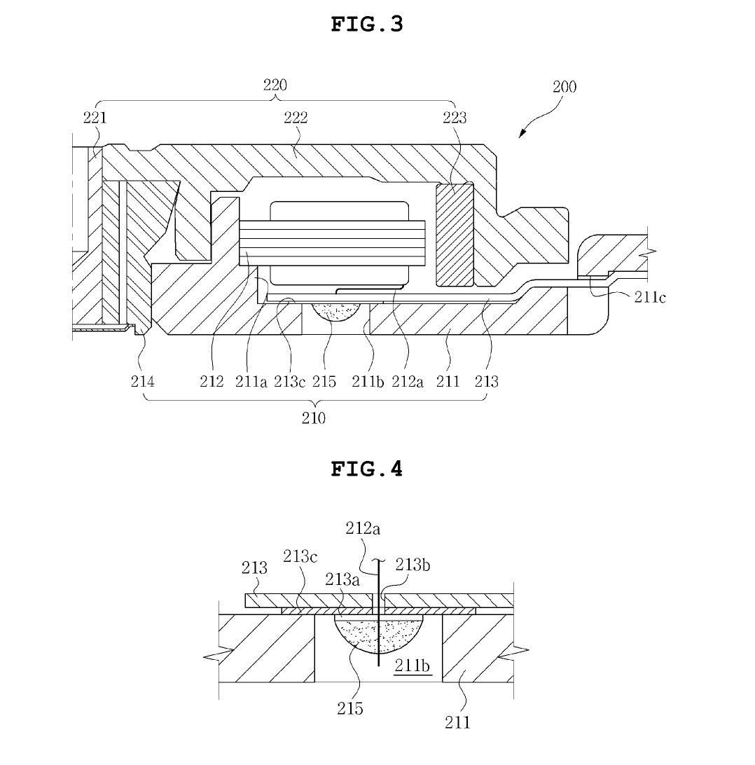

As illustrated in FIG. 3, in a spindle motor 200 according to a second embodiment of the invention, a core 212 around which a coil 212a is wound is coupled to a holder 211a of a base plate 211, a flexible printed circuit 213 is disposed between the core 212 and the base plate 211, and a sleeve 214 is then assembled to the center of the base plate 211, thereby configuring a stator 210. In addition, a shaft 221 is installed in a shaft direction in the sleeve 214, a hub 222 is assembled to an upper portion of the shaft 221, and a magnet 223 is then disposed on an inner side of the hub 222 to face the core 212, thereby configuring a rotor 220.

Therefore, in the spindle motor 200 according to the second embodiment of the invention, the rotor 220 is driven to be rotated on the shaft 221 by electromagnetic force occurring between the magnet 223 and the core 212 at the time of the application of a current through the flexible printed circuit 213, thereby rotating a disk mounted on an upper portion of the hub 222.

According to at least one embodiment, the base plate 211 has a through-hole 211b formed in a lower portion thereof on the drawing and an inlet hole 211c formed in one side thereof to allow the flexible printed circuit 213 to enter from the outside of the spindle motor 200 and accommodates a soldering part 215 formed by soldering the coil 212a in the through-hole 211b. According to at least one embodiment, the through-hole 211b is formed to have a size, which does not deteriorate structural rigidity of the base plate 211, a land part 213a and a coil leading hole 213b formed in the flexible printed circuit 213 are positioned in the through-hole 211b, so that the coil 212a is soldered in the through-hole 211b.

According to at least one embodiment, the flexible printed circuit 213 is formed using polyimide and has a pattern layer 213c made of a metal material formed on one surface thereof, wherein the pattern layer 213c is interposed between the base plate 211 and the flexible printed circuit 213. Specifically, the pattern layer 213c is formed on one surface of the flexible printed circuit 213 using copper foil and supports the flexible printed circuit 213 exposed to the outside through the through-hole 211b using material characteristics.

Therefore, even though a high pressure cleaning solution is sprayed through the through-hole 211b at the time of an ultrasonic cleaning for preventing foreign materials of the spindle motor 200, the flexible printed circuit 213 may more robustly cope with vibration by the pattern layer 213c, thereby preventing disconnection of the coil 212a electrically connected to the flexible printed circuit 213 by soldering.

As illustrated in FIG. 4, the flexible printed circuit 213 is a through-hole structure in which the coil leading hole 213b leading the coil 212a is formed to penetrate through the pattern layer 213c and the land part 213a to which the coil 212a led through the coil leading hole 213b is soldered is formed on a lower portion thereof. According to at least one embodiment, the soldering part 215 formed by soldering the coil 212a to the land part 213a is accommodated in the through-hole 211b.

Therefore, according to at least one embodiment, the coil 212a led through the coil leading hole 213b is soldered to the land part 213a in the through-hole 211b. As a result, the rotor 220 is driven to be rotated on the shaft 221 by electromagnetic force occurring between the magnet 223 and the core 212 at the time of the application of a current through the flexible printed circuit 213, thereby rotating a disk mounted on an upper portion of the hub 222.

### Third Exemplary Embodiment

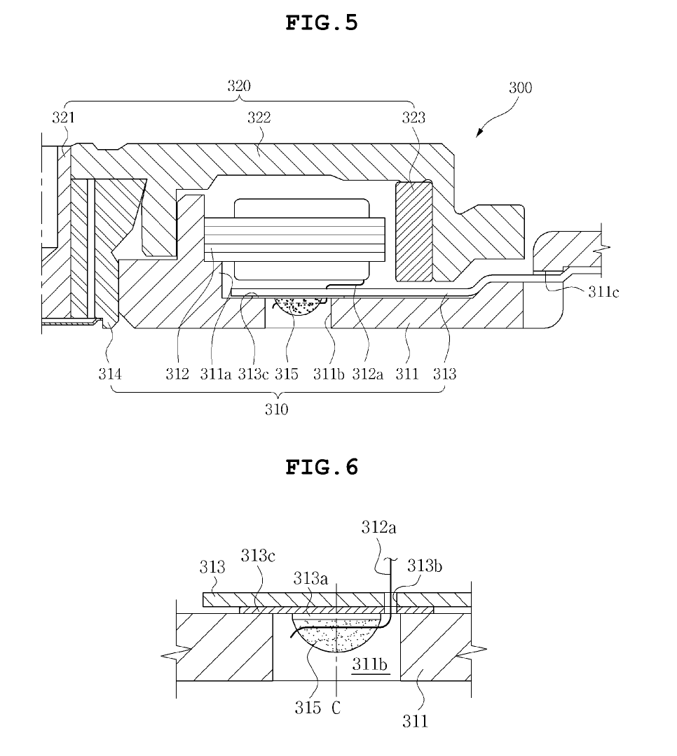

As illustrated in FIG. 5, in a spindle motor 300 according to a third embodiment of the invention, a core 312 around which a coil 312a is wound is coupled to a holder 311a of a base plate 311, a flexible printed circuit 313 is disposed between the core 312 and the base plate 311, and a sleeve 314 is then assembled to the center of the base plate 311, thereby configuring a stator 310. In addition, a shaft 321 is installed in a shaft direction in the sleeve 314, a hub 322 is assembled to an upper portion of the shaft 321, and a magnet 323 is then disposed on an inner side of the hub 322 to face the core 312, thereby configuring a rotor 320.

Therefore, in the spindle motor 300 according to the third embodiment of the invention, the rotor 320 is driven to be rotated on the shaft 321 by electromagnetic force occurring between the magnet 323 and the core 312 at the time of the application of a current through the flexible printed circuit 313, thereby rotating a disk mounted on an upper portion of the hub 322.

According to at least one embodiment, the base plate 311 has a through-hole 311b formed in a lower portion thereof on the drawing and an inlet hole 311c formed in one side thereof to allow the flexible printed circuit 313 to enter from the outside of the spindle motor 300 and accommodates a soldering part 315 formed by soldering the coil 312a in the through-hole 311b. According to at least one embodiment, the through-hole 311b is formed to have a size, which does not deteriorate structural rigidity of the base plate 311, a land part 313a and a coil leading hole 313b formed in the flexible printed circuit 313 are positioned in the through-hole 311b, so that the coil 312a is soldered in the through-hole 311b.

According to at least one embodiment, since the size of the land part 313a is reduced by forming the land part 313a in the through-hole 311b, the land part 313a and the coil leading hole 313b are formed to be separated from each other to prevent cold soldering and disconnection due to the reduction in the size of the land part 313a.

Meanwhile, the flexible printed circuit 313 is formed using polyimide and has a pattern layer 313c made of a metal material formed on one surface thereof, wherein the pattern layer 313c is interposed between the base plate 311 and the flexible printed circuit 313. Specifically, the pattern layer 313c is formed on one surface of the flexible printed circuit 313 using copper foil and supports the flexible printed circuit 313 exposed to the outside through the through-hole 311b.

Therefore, even though a high pressure cleaning solution is sprayed through the through-hole 311b at the time of an ultrasonic cleaning for preventing foreign materials of the spindle motor 300, the flexible printed circuit 313 more robustly copes with vibration by the pattern layer 313c, thereby preventing disconnection of the coil 312a electrically connected to the flexible printed circuit 313 by soldering.

As illustrated in FIG. 6, the flexible printed circuit 313 is a through-hole structure in which the coil leading hole 313b leading the coil 312a is formed and the land part 313a to which the coil 312a led through the coil leading hole 313b is soldered is formed on a lower portion thereof. According to at least one embodiment, the coil leading hole 313b is separated from the land part 313a to be formed at a position out of the land part 313a, as described above.

Thus, the coil leading hole 313b is formed to be separated from the land part 313a, such that the center thereof is spaced apart from a central shaft C of the through-hole 311b. However, the coil leading hole 313b is positioned in the through-hole 311b, so that the coil 312a is easily led.

Therefore, according to at least one embodiment, the coil 312a led through the coil leading hole 313b is soldered to the land part 313a in a state in which the coil 312a is bent in a horizontal direction on the drawing in the through-hole 311b, thereby increasing a length which is in contact with the soldering part 315 formed by soldering the coil 312a to prevent cold soldering and disconnection.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A spindle motor, comprising:
a stator comprising a base plate having a through-hole formed therein, a core provided in the base plate, and a flexible printed circuit applying a current to the core; and
a rotor comprising a magnet facing the core,
wherein the flexible printed circuit comprises:
a land part formed on one surface of the flexible printed circuit to allow a coil, which is wound around the core to be soldered and connected thereto, and
a coil leading hole formed to be in communication with the through-hole and formed at a position out of the land part to be separated.

2. The spindle motor of claim 1, wherein the base plate is provided with an inlet hole through which the flexible printed circuit enters.

3. The spindle motor of claim 2, wherein the inlet hole is formed in one side of the base plate.

4. The spindle motor of claim 2, wherein the land part and the coil leading hole are positioned in the through-hole.

5. A spindle motor, comprising:
a stator comprising a base plate having a through-hole formed therein, a core provided in the base plate, and a flexible printed circuit applying a current to the core; and
a rotor comprising a magnet facing the core,
wherein the flexible printed circuit comprises:
a pattern layer formed on one surface of the flexible printed circuit, the pattern layer being made of a metal material and being interposed between the flexible printed circuit and the base plate,
a land part to which a coil wound around the core is soldered and connected, the land part being formed on the pattern layer, and
a coil leading hole formed to penetrate through the pattern layer.

6. The spindle motor of claim 5, wherein the flexible printed circuit is made of polyimide.

7. The spindle motor of claim 5, wherein the pattern layer is made of copper foil.

8. The spindle motor of claim 5, wherein the base plate is provided with an inlet hole through, which the flexible printed circuit enters.

9. The spindle motor of claim 8, wherein the inlet hole is formed in one side of the base plate.

10. The spindle motor of claim 8, wherein the land part and the coil leading hole are positioned in the through-hole.

11. The spindle motor of claim 5, wherein the coil leading hole is formed at a position out of the land part to be separated.
